(19) United States
(12) Patent Application Publication
(10) Pub. No.: US 2017/0033989 A1
(43) Pub. Date: Feb. 2, 2017

(54) SHAREABLE CODE OBJECTS FOR ACCESSORIES AND USER DEVICES

(71) Applicant: Apple Inc., Cupertino, CA (US)

(72) Inventors: Shyam S. Toprani, Los Altos, CA (US); Jason J. Yew, Palo Alto, CA (US); Shailesh Rathi, San Jose, CA (US)

(73) Assignee: Apple Inc., Cupertino, CA (US)

(21) Appl. No.: 14/958,677

(22) Filed: Dec. 3, 2015

Related U.S. Application Data
(60) Provisional application No. 62/199,417, filed on Jul. 31, 2015.

(51) Int. Cl. H04L 12/24

(52) U.S. Cl. CPC H04L 41/0813

(57) ABSTRACT

Shareable code objects (including a data object and/or executable program code) can be shared between accessories and mobile devices to facilitate interoperation of accessories and mobile devices. For instance, a shareable code object that contains configuration data for a particular accessory can be obtained by a mobile device from one accessory and subsequently shared with other accessories of similar type when they connect to the mobile device. As another example, a shareable code object that includes executable program code can facilitate interoperation of the accessory and the mobile device without the user having to download and install an app.

### CROSS-REFERENCE TO RELATED APPLICATIONS

This application claims the benefit of U.S. Provisional Application No. 62/199,417, filed Jul. 31, 2015, the disclosure of which is incorporated by reference herein in its entirety.

### BACKGROUND

The present disclosure relates generally to communication between mobile electronic devices and accessories and in particular to shareable code objects for accessories and mobile devices.

Mobile electronic devices, such as smart phones, have become ubiquitous. Such devices, with their ability to connect to wide area networks such as the Internet, provide ready access to a wealth of information. Some mobile devices can connect to various other devices (referred to herein as “accessory devices” or simply “accessories”) that can support or enhance functionality of the mobile device. Accessories can vary in complexity and functionality. Examples of devices that can operate as accessories include chargers, speaker systems, headsets, health-related devices (e.g., blood glucose monitors, heart rate monitors), and automotive head units. Users may, over the course of time, use their mobile devices with a number of different accessories.

In addition, many mobile electronic devices can execute application programs (“apps”) to perform various functions. Some of these functions may pertain to interacting with accessories. For instance, an app designed to support a glucose monitor accessory may provide an interface to collect data from the accessory, present collected data to the user, and/or transmit data to the user's health care provider.

### SUMMARY

Users of mobile devices may connect their devices to different, but similar, accessories at different times. For example, a user may have a speaker dock at home and another speaker dock at the office. As another example, a user may own one car but occasionally drive other cars (e.g., rental cars), each of which may be able to interoperate with the user's mobile device. In such instances, the user may want to configure settings on the accessory to match personal preferences, which can lead to the user repeatedly providing similar configuration information to different accessories. Further, in some instances, the mobile device may need accessory-specific program code in order to interact with the accessory optimally (or at all). While an appropriate app may be available for download from a network location, it might not always be convenient for the user to download and install an app when connecting to a new accessory. Further, in some cases, the user might only be temporarily using the accessory (e.g., a rental car), in which case downloading and installing an app may not be desirable.

Accordingly, certain embodiments of the present invention relate to shareable code objects that can be shared between accessories and mobile devices. As used herein, a “shareable code object” can include a data object (e.g., configuration data for an accessory or accessory component) and/or executable program code (e.g., binary code, run-time compilable code, and/or interpreted code) that can be invoked by applications executing on the mobile device. The shareable code objects can facilitate interoperation of accessories and mobile devices. For instance, a shareable code object that contains configuration data for a particular accessory can be obtained by the mobile device from one accessory and subsequently shared with other accessories of similar type when they connect to the mobile device or in some cases shared back to the same accessory from which the shareable code object was received. This can allow a user to easily transfer configuration settings from one accessory to another or to restore previously established settings on an accessory. As another example, a shareable code object that includes executable program code can facilitate interoperation of the accessory and the mobile device without the user having to download and install an app.

In some embodiments, a mobile device and an accessory can establish a connection using an accessory communication protocol. Via this protocol, the mobile device can receive from the accessory a shareable code object and an object descriptor. After validating the shareable code object, the mobile device can make the shareable code object available to internal processes and/or other accessories. For example, the process executing on the mobile device can store the shareable code object in a persistent data store (e.g., in non-volatile memory or mass storage device) and can add an entry for the shareable code object to a listing of such objects (e.g., a lookup table), with the entry incorporating information from the object descriptor. Other processes on the mobile device and/or accessories that connect to the mobile device can request and obtain access to the shareable code object. The access can be read-only, or in some instances modification of the shareable code object can be permitted.

The following detailed description together with the accompanying drawings will provide a better understanding of the nature and advantages of the present invention.

### BRIEF DESCRIPTION OF THE DRAWINGS

FIG. 1 shows an example of a system suitable for implementing an embodiment of the present invention.

FIG. 2 shows an example of a user device persistently storing a copy of a shareable code object in the system of FIG. 1 according to an embodiment of the present invention.

FIG. 3 shows an example of a user device connected to an accessory in the system of FIG. 1 according to an embodiment of the present invention.

FIG. 4 shows an example of propagating a copy of a shareable code object in the system of FIG. 1 according to an embodiment of the present invention.

FIG. 5 shows an example of an accessory obtaining a copy of a shareable code object in the system of FIG. 1 according to an embodiment of the present invention.

FIG. 6A is a simplified block diagram of a user device according to an embodiment of the present invention.

FIG. 6B is a simplified block diagram of an accessory according to an embodiment of the present invention.

FIG. 7 is a block diagram showing further details of processes within a user device according to an embodiment of the present invention.

FIG. 8 shows a table 800 listing examples of messages that can be exchanged according to an embodiment of the present invention.

FIGS. 9A and 9B show a flow diagram of a process for sharing a shareable code objects between a user device and an accessory according to an embodiment of the present invention.

FIG. 10 shows an example of a list of shareable code objects according to an embodiment of the present invention.

FIG. 11 is a flow diagram of a process that can be used to validate a shareable code object according to an embodiment of the present invention.

FIG. 12 is a flow diagram of a process for synchronizing shareable code objects between a user device and a server according to an embodiment of the present invention.

### DETAILED DESCRIPTION

Certain embodiments of the present invention relate to shareable code objects that can be shared between accessories and mobile devices. As used herein, a “shareable code object” can include a data object (e.g., configuration data for an accessory or accessory component) and/or executable program code (e.g., binary code, run-time compilable code, and/or interpreted code) that can be invoked by applications executing on the mobile device. The shareable code objects can facilitate interoperation of accessories and mobile devices. For instance, a shareable code object that contains configuration data for a particular accessory can be obtained by the mobile device from one accessory and subsequently shared with other accessories of similar type when they connect to the mobile device or in some cases shared back to the same accessory from which the shareable code object was received. This can allow a user to easily transfer configuration settings from one accessory to another or to restore previously established settings on an accessory. As another example, a shareable code object that includes executable program code can facilitate interoperation of the accessory and the mobile device without the user having to download and install an app.

In some embodiments, a mobile device and an accessory can establish a connection using an accessory communication protocol. Via this protocol, the mobile device can receive from the accessory a shareable code object and an object descriptor. After validating the shareable code object, the mobile device can make the shareable code object available to internal processes and/or other accessories. For example, the process executing on the mobile device can store the shareable code object in a persistent data store (e.g., in non-volatile memory or mass storage device) and can add an entry for the shareable code object to a listing of such objects (e.g., a lookup table), with the entry incorporating information from the object descriptor. Other processes on the mobile device and/or accessories that connect to the mobile device can request and obtain access to the shareable code object. The access can be read-only, or in some instances modification of the shareable code object can be permitted.

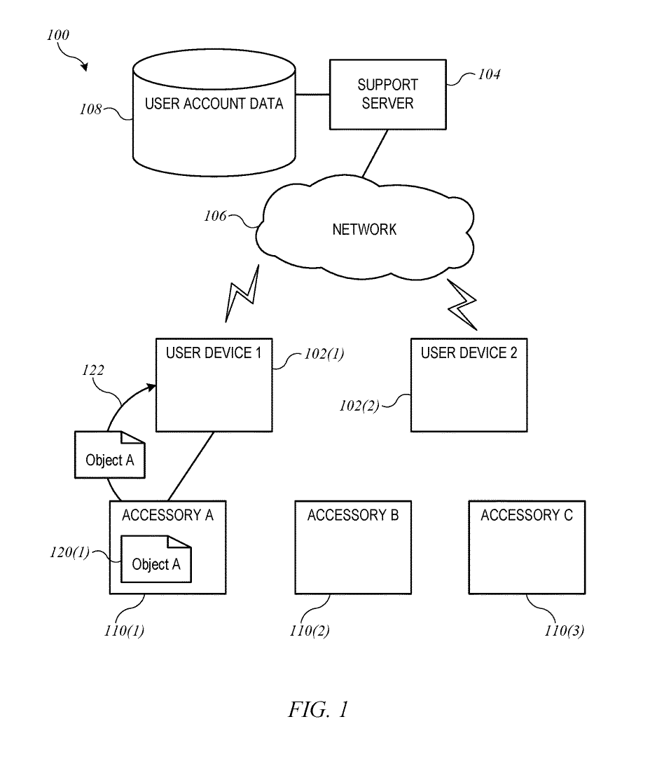

FIG. 1 shows an example of a system 100 suitable for implementing an embodiment of the present invention. System 100 includes user devices 102(1) and 102(2); it is to be understood that any number of user devices can be included. Each user device 102 can be an electronic device with which a user can interact to perform various operations, such as communication, information storage and retrieval, media playback, media creation (e.g., taking photos or videos, recording audio), game play, and so on. User devices 102 can include, for example, any or all of a media player, smart phone, personal digital assistant, tablet computer, wearable electronic device, desktop or laptop computer, or any other electronic device capable of data communication with other devices. In some embodiments, user devices 102 can include portable devices (meaning devices that are easily carried by a user from place to place for use in different places).

User devices 102 can communicate with a support server 104 via a network 106 (e.g., the Internet). Support server 104 can provide various support services to user devices 102. Examples of such services can include storing backup data for user devices 102, synchronizing stored data across different user devices 102, providing content and/or tools (e.g., media content, application programs) to user devices 102, supporting real-time event notification services to notify user devices 102 of various occurrences, supporting message exchange between devices of different users, etc. For purposes of accessing services provided by support server 104, a user can create an account with support server 104, e.g., by establishing a username and password. Support server 104 can store user-specific information (e.g., backup data, content, etc.) in association with the user's account in user account data store 108.

System 100 can also include various accessories 110(1), 110(2), 110(3) with which user devices 102 can interact; it is to be understood that any number of accessories can be provided. Each accessory 110 can be an electronic device that is capable of interacting with one or more of user devices 102, such as a speaker dock or speaker system, a media console, an automobile head unit, a massage chair, a lamp, a garage door opener, or the like.

For purposes of illustration, it is assumed that user devices 102(1) and 102(2) are different electronic devices belonging to the same user. For instance, user device 102(1) can be a mobile phone (e.g., a smart phone) and user device 102(2) can be a tablet. Both devices are said to “belong to” the same user when both devices have been linked to the same user account at support server 104. For example, the user may be prompted by each user device 102 to provide account credentials (e.g., username and password) for the user's account at support server 104; user device 102 can temporarily or persistently store the account credentials and use them to access services provided by support server 104. In some embodiments, support server 104 can synchronize stored data across different user devices 102 belonging to the same user. Such synchronization can happen with or without express user instructions.

In operation, a user device (e.g., user device 102(1)) can establish a connection with an accessory (e.g., accessory 110(1)) using a connection medium (or channel) that supports two-way data communication between the devices. For example, user device 102(1) can be connected to accessory 110(1) by a cable or through a wireless channel such as a channel using Bluetooth® communication protocols and standards promulgated by the Bluetooth SIG (including Bluetooth® Classic and/or Bluetooth® Smart communication protocols, referred to collectively herein as “Bluetooth communication”) or a wireless network complying with Wi-Fi® networking standards and protocols promulgated by the Wi-Fi Alliance (referred to herein as “Wi-Fi networks”). A particular connection medium is not required. Similarly, user device 102(2) can establish a connection with accessory 110(3). It is to be understood that at different times, a given user device 102 may be connected to different accessories or to no accessories at all. In some embodiments, each user device 102 is limited to connecting to no more than one accessory 110 at a time; in other embodiments, some or all user devices 102 can support concurrent connections to multiple accessories 110. Similarly, in some embodiments, each accessory 110 is limited to connecting to no more than one user device 102 at a time; in other embodiments, some or all accessories 110 can support concurrent connections to multiple user devices 102. In addition, there can be instances where a single user device, e.g., user device 102(1) and a single accessory, e.g., accessory 110(1) are concurrently connected via multiple channels.

In some instances, accessory 110(1) may be configurable by the user to accommodate the user's particular needs or preferences. For instance, accessory 110(1) might be a speaker dock with user-configurable settings such as volume, equalizer, balance, or the like. As another example, accessory 110(1) might be a car seat with user-configurable settings such as height, distance from steering wheel, seat back tilt angle, etc. Depending on implementation, the user can configure accessory 110(1) by interacting with user-operable controls on accessory 110(1) and/or by operating an appropriate user interface presented by user device 102(1) while user device 102(1) is connected to accessory 110(1).

It is contemplated that, at various times, the same user may use different accessories 110 of a similar type. For example, the user may have a speaker dock at home and another at work. Or the user may drive different cars at different times (e.g., different cars owned by the user, rental cars, cars obtained through a car-sharing service, etc.). For purposes of illustration, it is assumed that accessories 110(1) and 110(2) are different accessories of a similar type, such as car seats in two different cars.

In accordance with certain embodiments of the present invention, when the user configures accessory 110(1), accessory 110(1) can create or update a shareable code object 120(1) representing the configuration. Shareable code object 120(1) can represent configuration data for the accessory using a structured format (e.g., WL, JSON, or the like) to represent the current state of any or all user-configurable settings of accessory 110(1). While connected to user device 102(1), accessory 110(1) can provide a copy of shareable code object 120(1) to user device 102(1), as indicated by arrow 122. Providing the copy can occur with or without user intervention; examples are described below.

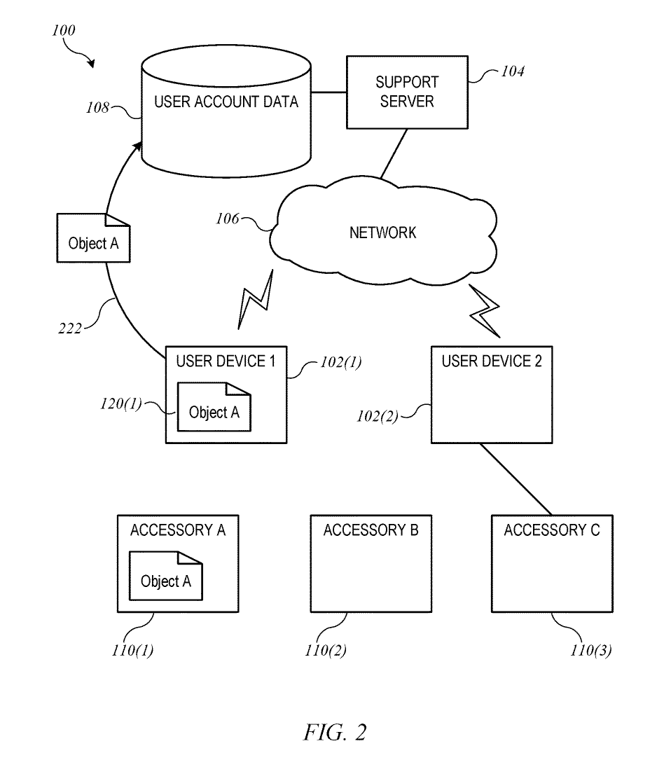

As shown in FIG. 2, user device 102(1) can persistently store a copy of shareable code object 120(1), such that even after the connection to accessory 110(1) is terminated, user device 102(1) retains its copy of shareable code object 120(1). User device 102(1) can also provide a copy of shareable code object 120(1) to support server 104 to be stored in user account data 108, as indicated by arrow 222. This can occur, e.g., as part of a synchronization operation; examples are described below.

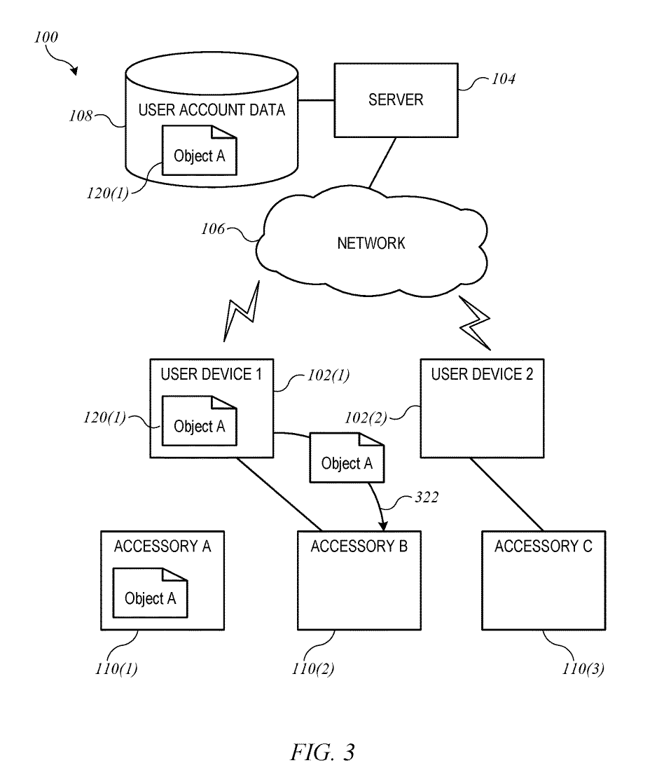

In some embodiments, user device 102(1) can share persistently stored shareable code object 120(1) with other accessories. For example, as shown in FIG. 3, after persistently storing shareable code object 120(1), user device 102(1) can connect to accessory 110(2). If accessory 110(2) is of a common type with accessory 110(1), then accessory 110(2) can obtain a copy of shareable code object 120(1) from user device 102(1), as indicated by arrow 322. Having obtained shareable code object 120(1), accessory 110(2) can adjust its configuration according to the settings information provided in shareable code object 120(1). Providing the copy can occur with or without user intervention; examples are described below. Further, sharing of shareable code objects between a user device and different accessories can occur independently of whether the shareable code object is synchronized with support server 104.

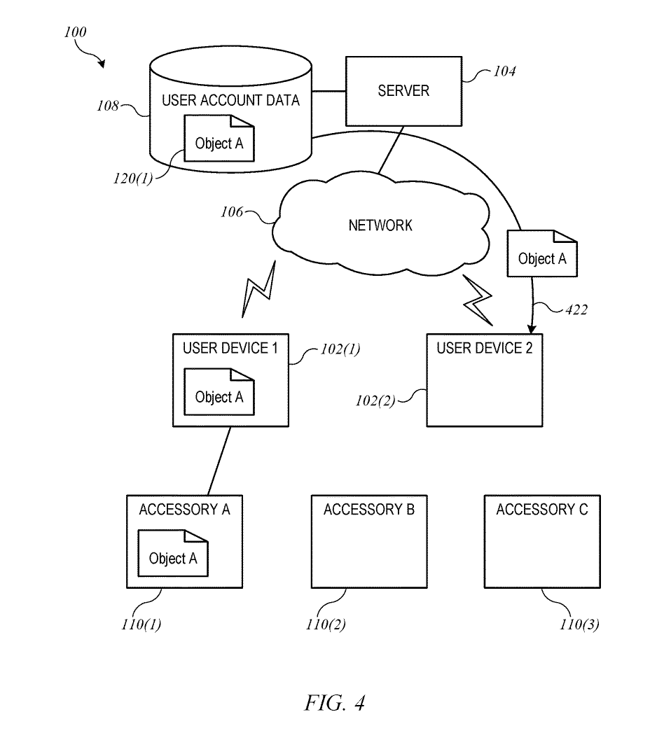

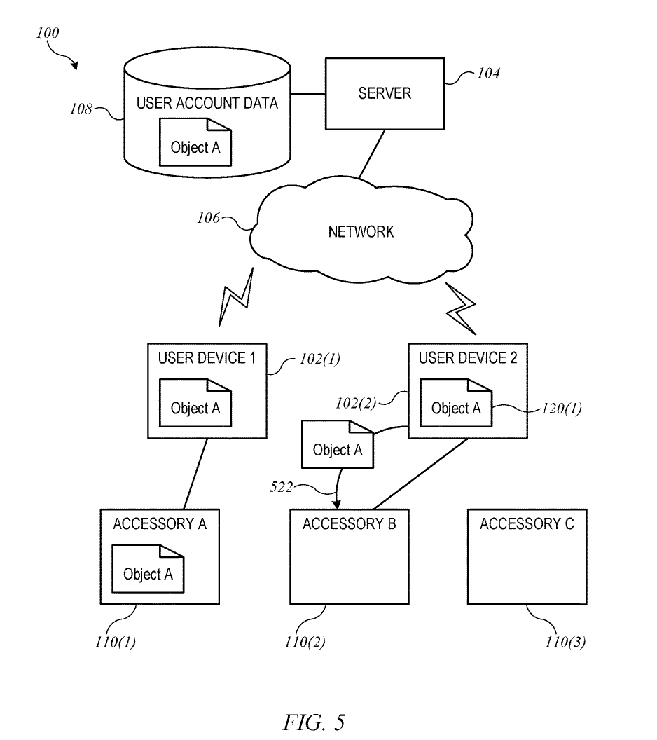

In some embodiments, persistently stored shareable code objects can be shared across user devices belonging to the same user. For example, as described above with reference to FIG. 2, support server 104 can obtain a copy of shareable code object 120(1) during a synchronization operation with user device 102(1). As shown in FIG. 4, support server 104 can propagate a copy of shareable code object 120(1) to user device 102(2) during a synchronization operation, as shown by arrow 422. User device 102(2) can persistently store its copy of shareable code object 120(1). Subsequently, as shown in FIG. 5, when user device 102(2) connects to accessory 110(2), accessory 110(2) can obtain a copy of shareable code object 120(1) from user device 102(2), as indicated by arrow 522.

Sharing of shareable code objects in the manner described can allow the user to easily experience a consistent interaction with different accessories connected to the same user device or different user devices. For example, suppose that accessory 110(1) and accessory 110(2) are car seats in two different cars that a user drives at different times. Each car seat can communicate with user devices, either directly or through a head unit in the car or the like. The user can configure car seat accessory 110(1) to her liking, e.g., manually adjusting the seat height, position relative to steering wheel, tilt angle, and any other adjustable settings. These settings can be represented as shareable code object 120(1) and persistently stored on user device 102(1). Thereafter, someone else may drive the car in which car seat accessory 110(1) is installed and change the settings. When the user returns to the car, user device 102(1) can provide shareable code object 120(1) to car seat accessory 110(1), allowing car seat accessory 110(1) to restore the user's preferred settings.

In addition, the user may also sometimes drive a different car, in which car seat accessory 110(2) is installed. Rather than having to manually adjust car seat accessory 110(2), the user can connect user device 102(1) to car seat accessory 110(2). Car seat accessory 110(2) can obtain shareable code object 120(1) from user device 102(1) and can adjust its own settings based on shareable code object 120(1). Similarly, where shareable code object 120(1) is shared among all the user's devices (e.g., via synchronization with support server 104), the user can obtain the same accessory experience even if different user devices 102 connect to an accessory.

It should be noted that the two car seat accessories need not be of identical type. For instance, they can be installed in cars made by different manufacturers. In some embodiments, a shareable code object can specify configuration settings using units that can be translated to the setting scale implemented by a particular manufacturer. For example, rather than specifying seat height as a percentage within a range, seat height can be specified in absolute units, such as distance in centimeters from the floor to the back of the seat pan. Similarly, a longitudinal (forward/backward) seat position can be specified as a front-to-rear distance in centimeters between a reference point on the steering wheel (or the pedals) and the back of the seat pan. Each accessory can translate the settings specified in the shareable code object according to its own ranges and options.

In some embodiments, a shareable code object can be received by a user device from an accessory and returned by the user device to the same accessory at a later time. For example, accessory 110(1) can be a car seat in a car that the user of user device 102(1) and another person regularly drive. After the user of user device 102(1) initially adjusts car seat accessory 110(1) to preferred settings (e.g., a preferred seat position), car sear accessory 110(1) can provide shareable code object 120(1) containing information about the user's preferred settings to user device 102(1). At a later time, another person may drive the car and adjust car seat accessory 110(1) to different settings. When the user of user device 102(1) thereafter returns to the car, user device 102(1) can provide shareable code object 120(1) back to car seat accessory 110(1), which can restore its settings according to the information contained in shareable code object 120(1). In a similar manner, all individuals who use the car in which car seat accessory 110(1) is installed can use their own user devices to retain their own preferred car-seat settings. Thus, car seat accessory 110(1) can automatically adjust its settings to accommodate different drivers, without car seat accessory 110(1) needing to store settings information for multiple drivers.

Further, while a car seat is used as an example, the same principles can be applied to any other instance where multiple accessories of different types exist. For instance, the accessories might be microwave ovens that differ as to power output. A user can, through experimentation, discover a particular “recipe” for heating a food item in a first microwave oven (e.g., a combination of power level and cooking time) that produces a desired result (e.g., even heating, preserving crispness, etc.). The user can save this “recipe” as a shareable code object and communicate it to other microwave ovens the user may operate. In some instances, the recipe can be specified in absolute units (e.g., power output in watts rather than a power level as a percentage of maximum or a specific power setting, such as “medium,” on the originating microwave oven).

Similarly, in instances where a user repeatedly interacts with a particular accessory, the user's device can obtain a shareable code object from the accessory and later provide the same shareable code object back to the accessory to restore or replicate the user's preferred settings. For instance, in the case of a microwave oven, the user can save a “recipe” to the user device as a shareable code object and communicate it from the user device to the same microwave at a later time to replicate the recipe, without the microwave needing to persistently store any information.

In addition, in some embodiments, the shareable code object is not limited to static parameter settings. For example, a shareable code object can also include executable code in addition to or instead of static parameter settings. Executable code can be provided in various formats, including a script that can be interpreted and executed by a processor, compiled binary code that can be executed by a processor, and/or compilable code that can be compiled at run-time. The executable code can include code to be executed by a processor on the user device, e.g., as an extension to an application program (“app”) installed on the user device. In addition or instead, the executable code can include code to be executed by a processor on the accessory. The executable code can, for example, provide optimized interactions between the accessory and the user device. As a shareable code object 120, the executable code can be shared to different accessories 110 and/or different user devices 102 in the manner described above. In some embodiments, safeguards can be put into place to prevent malicious executable code from being propagated via a shareable code object; examples are described below.

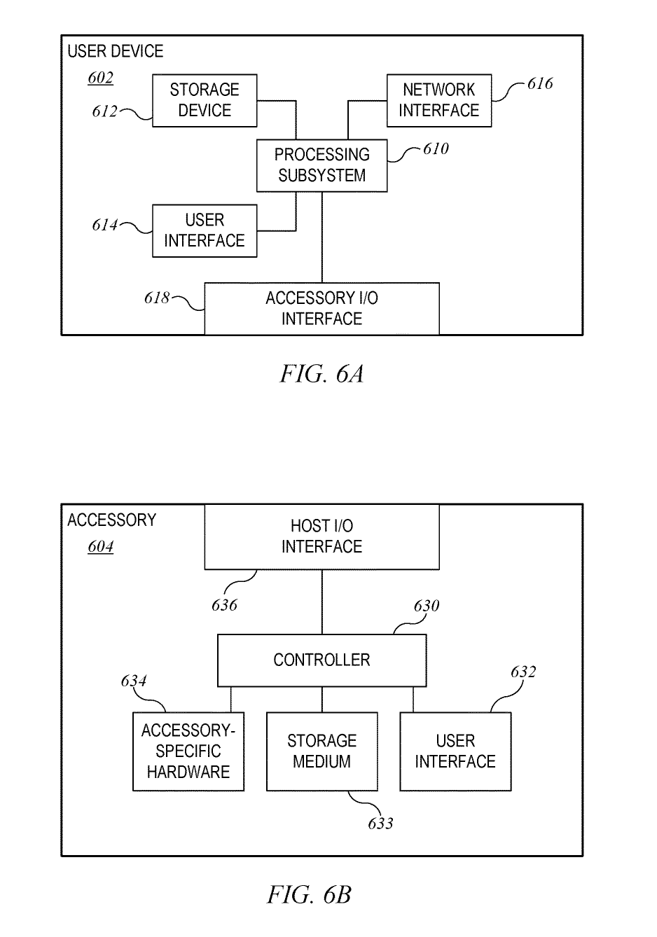

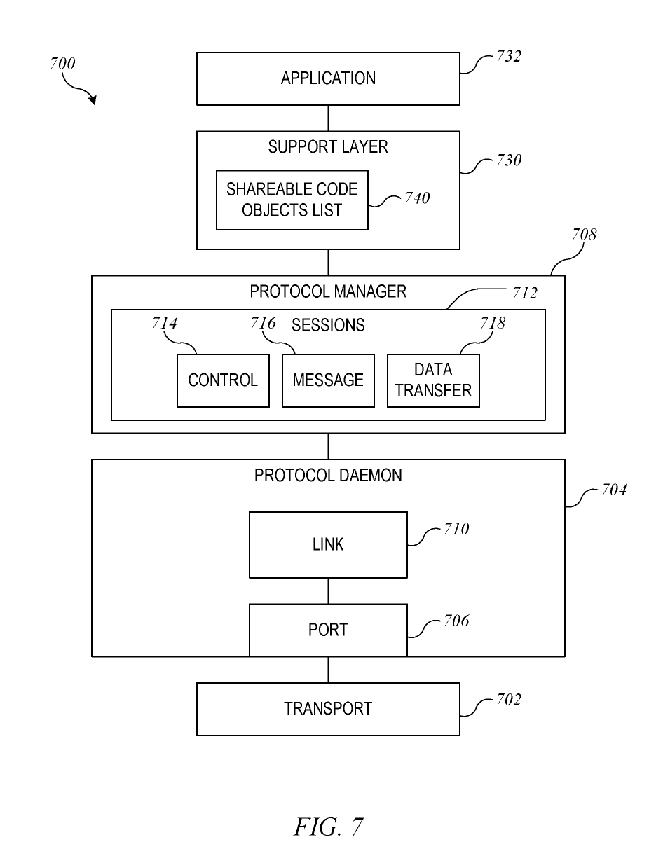

FIG. 6A is a simplified block diagram of a user device 602 according to an embodiment of the present invention. In this embodiment, user device 602 (e.g., implementing any of user devices 102 of FIG. 1) can provide computing, communication and/or media playback capability. User device 602 can include processing subsystem 610, storage device 612, user interface 614, network interface 616, and accessory input/output (I/O) interface 618. User device 602 can also include other components (not explicitly shown) such as a battery, power controllers, and other components operable to provide various enhanced capabilities.

Storage device 612 can be implemented, e.g., using disk, flash memory, or any other non-transitory storage medium, or a combination of media, and can include volatile and/or non-volatile media. In some embodiments, storage device 612 can store data objects such as audio files, video files, image or artwork files, information about a user's contacts (names, addresses, phone numbers, etc.), information about a user's scheduled appointments and events, notes, and/or other types of information. In some embodiments, storage device 612 can also store one or more application programs to be executed by processing subsystem 610 (e.g., video game programs, personal information management programs, media playback programs, etc.) and/or one or more operating system programs or other firmware to implement and support various device-level capabilities including a protocol stack to support communication with an accessory according to an accessory protocol. Storage device 612 can also be used to persistently store shareable code objects received by user device 602.

User interface 614 can include input devices such as a touch pad, touch screen, scroll wheel, click wheel, dial, button, switch, keypad, microphone, or the like, as well as output devices such as a video screen, indicator lights, haptic devices, speakers, headphone jacks, or the like, together with supporting electronics (e.g., digital-to-analog or analog-to-digital converters, signal processors, or the like). A user can operate input devices of user interface 614 to invoke the functionality of user device 602 and can view and/or hear output from user device 602 via output devices of user interface 614.

Processing subsystem 610 can be implemented as one or more integrated circuits, e.g., one or more single-core or multi-core microprocessors or microcontrollers, examples of which are known in the art. In operation, processing subsystem 610 can control the operation of user device 602. In various embodiments, processing subsystem 610 can execute a variety of programs in response to program code and can maintain multiple concurrently executing programs or processes. At any given time, some or all of the program code to be executed can be resident in processing subsystem 610 and/or in storage media such as storage device 612.

Through suitable programming, processing subsystem 610 can provide various functionality for user device 602. For example, processing subsystem 610 can detect accessories connected to accessory I/O interface 618 and can initiate various sessions for purposes of communicating with accessory 604 (or other accessories), and such communication can include parsing messages received from accessory 604. Processing subsystem 610 can also set up and maintain a link layer for managing communications between the sessions and one or more accessories. Examples of sessions and link layers are described below. Processing subsystem 610 can also execute other programs and/or processes to control other functions of user device 602, including application programs that may be stored in storage device 612; in some embodiments, these application programs may include instructions that result in interactions with accessory 604, and processing subsystem 610 can execute such interactions using a protocol stack (e.g., as described below).

Network interface 616 can provide voice and/or data communication capability for user device 602. In some embodiments network interface 616 can include radio frequency (RF) transceiver components for accessing wireless voice and/or data networks (e.g., using cellular telephone technology, advanced data network technology such as 3G or LTE, Wi-Fi, other IEEE 802.11 family standards, or other mobile communication technologies, or any combination thereof); components for short-range wireless networking (e.g., using Bluetooth standards); components supporting proprietary wireless networking technologies such as custom mesh networks, direct wireless links, or the like; GPS receiver components; and/or other components. In some embodiments network interface 616 can provide wired network connectivity (e.g., Ethernet) in addition to or instead of a wireless interface. Network interface 616 can be implemented using a combination of hardware (e.g., driver circuits, antennas, modulators/demodulators, encoders/decoders, and other analog and/or digital signal processing circuits) and software components.

Accessory I/O interface 618 can allow user device 602 to communicate with various accessories. For example, accessory I/O interface 618 can support connections to a computer, an external keyboard, a speaker dock or media playback station, a digital camera, a radio tuner, an in-vehicle entertainment system or head unit, an external video device, a memory card reader, and so on. In some embodiments, accessory I/O interface 618 can support wireless communication (e.g., via Wi-Fi, Bluetooth, or other wireless transports). The same wireless transceiver hardware as network interface 616 can be used for both networking and accessory communication; for instance, as described below, a Wi-Fi network or other wireless network can be used as a transport for accessory-protocol messages. Additionally or instead, in some embodiments, accessory I/O interface 618 can include a connector, such as connectors corresponding to the connectors used in various iPod®, iPhone®, and iPad® products, as well as supporting circuitry. Thus, accessory I/O interface 618 can support multiple communication channels, and a given accessory can communicate with user device 602 using any or all of these channels.

FIG. 6B is a simplified block diagram of an accessory 604 according to an embodiment of the present invention. Accessory 604 (e.g., implementing any of accessories 110 of FIG. 1) can include controller 630, user interface device 632, storage medium 633, other accessory-specific hardware 634, and host I/O interface 636. Accessory 604 is representative of a broad class of accessories that can interoperate with a user device (e.g., user device 602), and such accessories can vary widely in capability, complexity, and form factor. Various accessories may include components not explicitly shown in FIG. 6, including but not limited to storage devices (disk, flash memory, etc.) with fixed or removable storage media; video screens, speakers, or ports for connecting to external audio/video devices; camera components such as lenses, image sensors, and controls for same (e.g., aperture, zoom, exposure time, frame rate, etc.); microphones for recording audio (either alone or in connection with video recording); and so on. In addition, some accessories may provide an additional interface (not shown) that can connect to and communicate with another accessory.

Controller 630 can include, e.g., one or more single-core or multi-core microprocessors and/or microcontrollers executing program code to perform various functions associated with accessory 604. For example, where accessory 604 incorporates a user-operable control, controller 630 can interpret user operation of the control and responsively invoke functionality of accessory 602; in some instances, the invoked functionality can include sending information to and/or receiving information from user device 602. For example, the user may adjust a configuration setting of accessory 604, and controller 630 may create or update a shareable code object based on the setting and provide the shareable code object to user device 602. Controller 630 can also implement a protocol stack to support communication with a user device according to an accessory protocol.

User interface 632 may include user-operable input devices such as a touch pad, touch screen, scroll wheel, click wheel, dial, button, switch, keypad, microphone, or the like, as well as output devices such as a video screen, indicator lights, speakers, headphone jacks, or the like, together with supporting electronics (e.g., digital-to-analog or analog-to-digital converters, signal processors, or the like). Depending on the implementation of a particular accessory 602, a user can operate input devices of user interface 632 to invoke functionality of accessory 602.

Storage medium 633 can incorporate any type of data storage media, including but not limited to disk, flash memory, or any other non-transitory storage medium, or a combination of media, and can include volatile and/or non-volatile media. Storage medium 633 can be used to store program code to be executed by controller 630, data objects received from user device 602, and any other data or instructions that may be generated and/or used in the operation of accessory 604. Storage medium 633 can also store shareable code objects that can be created or updated by accessory 604 and shared with user device 602. In some embodiments, storage medium 633 can include only volatile storage, e.g., for accessories that can boot by receiving code from another device, either point-to-point or via a network.

Accessory-specific hardware 634 can include any other components that may be present in accessory 604 to enable its functionality. For example, in various embodiments accessory-specific hardware 634 can include one or more storage devices using fixed or removable storage media; GPS receiver; a network interface; power supply and/or power management circuitry; environmental sensors (e.g., temperature sensor, pressure sensor, accelerometer, chemical sensor, etc.); actuators (e.g., motor controllers, switches, or the like); and so on. It is to be understood that any type of accessory functionality can be supported by providing appropriate accessory-specific hardware 634.

Host I/O interface 636 can allow accessory 604 to communicate with user device 602. In some embodiments, host I/O interface 636 can support wireless communication (e.g., via Wi-Fi, Bluetooth, or other wireless transports) and can include appropriate transceiver and signal processing circuitry and software or firmware. Additionally or instead, in some embodiments, host I/O interface 636 can include a connector that mates directly with a connector included in user device 602, such as a connector complementary to the connectors used in various iPod®, iPhone®, and iPad® products.

Accessory 604 can be any electronic apparatus that interacts with user device 602. In some embodiments, accessory 604 can provide remote control over operations of user device 602, or a remote user interface that can include both input and output controls (e.g., a display screen to display current status information obtained from user device 602). Accessory 604 in various embodiments can control any function of user device 602 and can also receive data and/or control signals from user device 602. In other embodiments, user device 602 can control operations of accessory 604, such as retrieving stored data from a storage medium of accessory 604, initiating an image capture operation by a camera incorporated into accessory 604, etc. In some embodiments, accessory 604 can concurrently have communication channels with user device 602 and one or more other devices using the same protocol or different protocols as desired. In some embodiments, a user can configure settings of accessory 604, either by interacting with user interface 632 or with user interface 614 of connected user device 602. Accessory 604 can provide the settings data as a shareable code object to user device 602. In some embodiments, accessory 604 can provide a shareable code object containing executable code, and user device 602 can execute the code.

It will be appreciated that the system configurations and components described herein are illustrative and that variations and modifications are possible. The host device and/or accessory may have other capabilities not specifically described herein (e.g., mobile phone, global positioning system (GPS), broadband data communication, Internet connectivity, etc.).

Further, while the host device and accessory are described herein with reference to particular blocks, it is to be understood that these blocks are defined for convenience of description and are not intended to imply a particular physical arrangement of component parts. Further, the blocks need not correspond to physically distinct components, and the same physical components can be used to implement aspects of multiple blocks. Blocks can be configured to perform various operations, e.g., by programming a processor or providing appropriate control circuitry, and various blocks might or might not be reconfigurable depending on how the initial configuration is obtained. Embodiments of the present invention can be realized in a variety of apparatus including electronic devices implemented using any combination of circuitry and software.

Accessory I/O interface 618 of user device 602 and host I/O interface 636 of accessory 604 allow user device 602 to be connected with accessory 604 and subsequently disconnected from accessory 604. As used herein, a user device and an accessory are “connected” whenever a communication channel specifically designated for accessory protocol communication is established between their respective interfaces and “disconnected” when the channel is terminated. Such connection can be achieved via direct physical connection, e.g., with mating connectors; indirect physical connection, e.g., using a cable; and/or wireless connection, e.g., via Wi-Fi or Bluetooth. In some embodiments, the communication channel for accessory protocol communication can piggyback on another transport (e.g., a wired or wireless power transport) or can include tunneling of accessory-protocol communications inside another protocol (e.g., an HTTP or HTTPS protocol).

In some embodiments, a user device and an accessory can communicate while connected by exchanging messages and data according to an “accessory protocol,” which can be a proprietary or open protocol developed by a manufacturer of host devices (e.g., the iPod Accessory Protocol (“iAP”) developed by Apple Inc.). The messages and data can be communicated, e.g., using a wired or wireless transport medium provided by the relevant I/O interfaces. The accessory protocol can be largely or entirely transport-agnostic; that is, the same message and data formats can be used regardless of the transport medium (e.g., wired or wireless) or transport-level protocol that provides the channel via which accessory-protocol messages and data are exchanged. In some instances, the accessory protocol may specify a sequence of operations to establish a channel, and some or all these operations may be specific to a particular transport medium or transport-level protocol.

The accessory protocol can define a “universe” of messages that can be exchanged between user device 602 and accessories connected thereto, such as accessory 604. The message format can include, e.g., a start bit or bit sequence to indicate that what follows is a message code, followed by an actual message code that can be interpreted and acted on by the recipient. At least some of the message codes may have one or more associated parameters defined by the protocol, and a message can include values for any such parameters in addition to the message code. In some instances, the protocol can further specify a behavior for a recipient in the event that a particular parameter associated with a message code is not received or in the event that an unexpected parameter is received with a message code. The number of parameters can be different for different messages, and in some instances, a parameter may have variable length. In some embodiments, the message codes can be defined such that a given message code is valid in only one direction. Other message structures can also be used.

The accessory protocol can also define a format for the packetizing of messages at a link layer. For instance, the accessory protocol may specify that a message is sent using one or more packets, each of which has a header and a payload. The header provides basic information (e.g., a start indicator; length of the packet; packet sequence number; identifier of a session with which the packet is associated, as described below), while the payload provides all or part of the message data. The packet can also include error-detection or error-correction codes as known in the art. The link layer can keep track of packets sent and/or received and can implement operations to verify packet delivery. For example, for received packets, the link layer can send acknowledgements, perform error checking, and request retransmission if an uncorrectable error is detected. For transmitted packets, the link layer can receive acknowledgements and can retransmit packets that were not acknowledged and/or for which the receiving device requests retransmission. These and other link-layer operations can be agnostic to packet content.

In some embodiments, the universe of messages defined by the accessory protocol can be logically grouped into a “general” message set and an “optional” message set. Every accessory and every user device (or host device) that use the accessory protocol can be required to support at least the general message set. This message set can include messages enabling the user device and the accessory to identify and authenticate themselves to each other and to provide information about their respective capabilities, including which (if any) of the messages in the optional set each supports. For example, the general message set can include a “detect” message that the accessory can send to the user device to initiate accessory-protocol communication, a “request identify” message (or detect message) that the user device can send to the accessory in response to the detect message to request that the accessory identify itself, and an identification message (or sequence of messages) that the accessory can send to the user device to provide identifying information. Identification can include, for example, providing basic information about the accessory device such as manufacturer, model name, serial number, firmware version, device class information; listing specific messages in the optional message set that the device is capable of sending and/or receiving; providing information about input/output capabilities, encryption capabilities; and so on. In some embodiments, identification can include providing information indicating whether the accessory device intends to send shareable code objects to the user device and/or receive shareable code objects from the user device. The general message set can also include authentication messages that the user device can use to verify the purported identity and capabilities of the accessory (or vice versa), and the accessory (or user device) may be blocked from invoking certain (or all) of the optional messages if the authentication is unsuccessful.

The optional message set can include messages related to various functionalities that might or might not be supported in a given accessory. For example, the optional message set can include simple remote control messages that allow an accessory to invoke a function of the user device or that allow a user device to invoke a function of an accessory (e.g., changing a setting), remote user interface messages that can be used to obtain information related to replicating all or part of a user interface of a user device on an accessory (or vice versa), messages that facilitate transfers of data objects between the host device and the accessory, and so on. Any combination of optional messages can be defined in an accessory protocol, and there is no requirement that a given accessory or host device support all (or even any) of the optional messages.

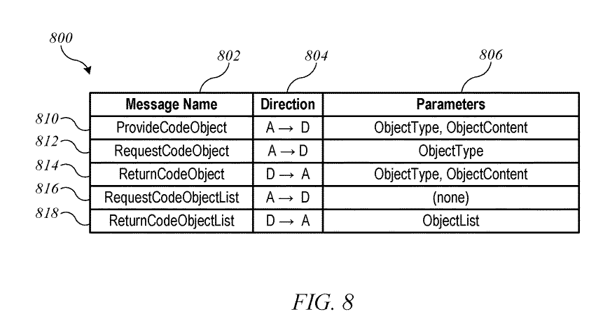

FIG. 7 is a block diagram showing further details of processes within user device 602 according to an embodiment of the present invention. The various processes shown can correspond to programs executing in processing subsystem 610 of FIG. 6 and can provide a protocol stack 700 for user device 602. A similar protocol stack can be implemented in accessory 604. In some embodiments, multiple processor chips or multiple processor cores within a single chip can be used to implement the various processes. Some or all of the processors can be programmable general-purpose processors executing software and/or firmware programs, or some or all can be digital signal processors, state machines with built-in functionality, or any combination thereof. Protocol stack 700 can be used for accessory-protocol communication

Physical transport 702 can include antennas, signal pins, drivers, digital-to-analog converters, encoders, RF circuitry, and other components operable to send and receive signals on a physical transport such as a pin, a wire, or an optical fiber; a wireless transport (e.g., an RF carrier wave); or the like. The particular details depend on the transport, and conventional or other transports can be used. In some embodiments, physical transport 702 implements a Wi-Fi transport and is capable of routing incoming and outgoing Wi-Fi communications to and from multiple different ports on the host device (including port 706 shown in FIG. 7); within the same host device, different ports can have different associated protocol stacks. Thus, for example, physical transport 702 can route to port 706 any incoming communications from an accessory with which an accessory-protocol connection to port 706 has been established and can route communications from other devices (e.g., a wireless-network access point such as a router) to other ports of the host device (not shown in FIG. 7). Examples of establishing connections to port 706 are described below.

Protocol daemon 704 can control accessory protocol communications by managing various physical or virtual ports. In some embodiments, protocol daemon 704 can define a port 706 corresponding to each established connection to an accessory. Although only one port 706 is shown, some embodiments allow multiple concurrent connections to accessories, and there can be multiple ports 706 connected to the same accessory or to different accessories. Each port 706 can interact with physical transport 702 (which can be the same transport or different transports for different ports 706) to send signals to and receive signals from an accessory connected on that port 706. In some instances, a virtual port 706 can be implemented as a software object (e.g., part of the device firmware); in other instances, port 706 can be connected to or associated with suitable communication hardware. For example, in the case of wireless communication, port 706 can be implemented as a software object to which physical transport 702 can selectively deliver incoming wireless signals that are addressed to port 706 and from which physical transport 702 can receive outgoing signals to be delivered wirelessly to other devices.

Protocol daemon 704 can extract inbound accessory-protocol messages received on port 706 (or any other active ports) and deliver them to a protocol manager 708. Protocol daemon 704 can also receive outbound accessory-protocol messages from protocol manager 708 and provide the messages to port 706 (or another active port) for delivery to an accessory connected to that port 706.

More specifically, protocol daemon 704 can include a link layer 710, which can be implemented as a software object (e.g., part of the device firmware) executing on appropriate hardware. In some embodiments, link layer 710 operates to create, send, receive, and read packets conforming the accessory protocol (e.g., as described above). For outbound communication, link layer 710 can receive a message from protocol manager 708, encapsulate the message into one or more packets, and send the packets via port 706 to physical transport 702. In some instances, e.g., where physical transport 702 implements Wi-Fi communication, physical transport 702 can encapsulate a link-layer packet (or a portion thereof) as the payload of a data packet that conforms to Wi-Fi or another wireless protocol.

For inbound communication, link layer 710 can receive a packet via port 706, extract the message, and provide the message to protocol manager 708 for processing. Where multiple ports 706 are connected, link layer 710 can manage the interleaving of communication across different connected ports 706, particularly where multiple ports share a common physical transport 702 (e.g., a wireless transport using an antenna common to all ports).

Protocol manager 708 can receive accessory-protocol messages from protocol daemon 704 and begin the process of interpreting the messages. Protocol manager 708 can receive all messages in the same format, regardless of port; thus the upper levels of the process stack shown in FIG. 7 can be isolated from the transport mechanism. Protocol manager 708 can deliver messages to a support layer 730 that acts as an intermediary between protocol manager 708 (and optionally other low-level device functions) and application 732, or in some instances directly to application 732.

Protocol manager 708 can include a session layer 712, which can be implemented as a software object (e.g., part of the device firmware) executing on appropriate hardware. Session layer 712 can operate to create and read messages conforming to the accessory protocol (e.g., the protocol described above). For outbound communication, session layer 712 can create a message, e.g., based on function calls from support layer 730 or directly from application 732, and provide the message to link layer 710 to be sent. For inbound communication, link layer 710 can provide a message extracted from a packet to session layer 712 for processing. Session layer 712 can interpret the message and send appropriate function calls to support layer 730 or directly to application 732.

In some embodiments, session layer 712 can create and define multiple sessions of different types, each adapted to handle different types of messages and data exchanges. Examples are shown in FIG. 7 as sessions 714, 716, 718. Each session can be assigned a unique session identifier (not shown) such that no two concurrently existing sessions in session layer 712 have the same session identifier. In some embodiments, session identifiers are assigned by the host device (or user device) as sessions are created, and the host device can communicate the assigned session identifier to the accessory (e.g., via a message on an already-existing session). Different session types can be defined to process different subsets of messages in the accessory protocol, and in some embodiments, the subsets can overlap.

A control session 714 can be configured to process all messages associated with the general message set of the accessory protocol, such as identification and authentication of a connected accessory; control session 714 can also determine what other types of sessions are permitted to communicate with the accessory. This determination can be based on accessory identification and authentication, capabilities of the host device and so on. In some embodiments, control session 714 has a fixed identifier with a value specified by the accessory protocol; this can allow the host and accessory to create control sessions with matching session identifiers without having to expressly communicate the identifier value that will be used.

A message session 716 can be created to handle at least some of the messages from the optional message set of the accessory protocol. For example, many messages may include relatively small amounts of parameters and/or other data, and message session 716 can be used to create and read such messages.

A data transfer session 718 can be created in response to a request to transfer data between the host device and an accessory. Different types of data transfer sessions can be used, including, for example, buffer transfer sessions for discrete data objects (such as a file) whose size is known prior to beginning the transfer and streaming data sessions for open-ended data transfers where the size is not known in advance (e.g., streaming media or application-specific messages that are forwarded to and from applications 732).

It is to be understood that the particular session types described herein are illustrative and that other session types can be defined in addition to or instead of those shown in FIG. 7. In some embodiments, multiple sessions with the same accessory can operate concurrently, sharing access to port 706 via link layer 710.

In some embodiments with multiple ports 706, session layer 712 can define a different set of sessions for each connected port. Each session can have a globally unique session identifier (e.g., the control session associated with a first port and the control session associated with a second port can have different identifiers). In some embodiments, each received packet contains a session identifier, and link layer 710 can route extracted messages to a particular session based on the session identifier; likewise, link layer 710 can route different outgoing messages to different ports based on the session identifier of the message's source. Link layer 710 can maintain a mapping of session identifiers to ports, and session layer 712 can operate without knowledge of what ports are currently defined or being used for a particular session. It is to be understood that multiple session identifiers can be mapped to the same port. Where multiple session identifiers are mapped to the same port, link layer 710 can manage the interleaving of communications to and from different sessions, transparently to session layer 712.

For inbound communication, one of the sessions 714-718 within protocol manager 708 can receive accessory-protocol messages from protocol daemon 704 and begin the process of interpreting the messages. Protocol manager 708 can receive all messages in the same format, regardless of port; thus the upper levels of the process stack shown in FIG. 7 can be isolated from the transport mechanism. Protocol manager 708 can deliver messages to a support layer 730 that acts as an intermediary between protocol manager 708 (and optionally other low-level device functions) and application 732, or in some instances directly to application 732.

Some or all of the sessions in session layer 712 can be initiated and terminated on demand. For example, control session 714 can be initiated when a new connection is detected and port 706 is initialized. Control session 714 can be used to process identification and authentication messages received from the accessory and determine whether a message session 716 should be created or not. In some embodiments, control session 714 can remain active until such time as a disconnection or termination of port 706 occurs. Message session 716 can be created in response to control session 714 determining that message session 716 should be created, e.g., upon successful identification and/or authentication of an accessory. Once created, message session 716 can remain active until such time as a disconnection or termination of port 706 occurs or until such time as control session 714 determines that message session 716 should be terminated (e.g., because a new identification message is received from the accessory on port 706).

Other sessions can be initiated (or created) later, in response to specific events. For example, message session 716 can receive a message from the accessory or an application requesting transfer of a data object. In response, message session 716 can initiate a data transfer session 718 to transfer the data object. In some embodiments, message session 716 may be prevented from initiating data transfer session 718 if control session 714 determines that the connected accessory is not authorized to perform the requested data transfer. Data transfer session 718, once created, can begin the transfer of the data object and can terminate once the transfer is complete. If another transfer is subsequently requested, another data transfer session can be created.

Application 732 can include one or more application programs implementing various functions of user device 602. Examples include an interface for navigating a database of media assets and for playing back assets of various types (e.g., audio, video, still images such as photos, etc.). Other examples include World Wide Web browsers, e-mail programs, personal information management applications (e.g., for managing calendar, tasks, contacts, etc.), geographic navigation programs (e.g., using GPS capability where present), remote control applications that interact with accessories, and the like. Depending on implementation, application 732 can be part of an operating system of user device 602, a separate program pre-loaded onto user device 602, or a program loaded onto user device 602 by a user.

Support layer 730 can facilitate access by application 732 to system-level services available in user device 600, including protocol manager 708 and protocol daemon 704. In some embodiments, support layer 730 can also facilitate access to shareable code objects that may be stored on user device 602. For example, support layer 730 can maintain a shareable code objects list 740 that provides information about shareable code objects stored on user device 602. Shareable code objects list 740 can be populated, e.g., by protocol manger 712, as shareable code objects are received from a connected accessory and stored at user device 602. In some embodiments, application 732 can read shareable code objects list 740 to determine whether a shareable code object is available that may be useful for execution of application 732, such as an object containing executable code. If so, application 732 can request execution of the shareable code object via an appropriate function call to support layer 730. In some embodiments, a connected accessory (e.g., accessory 604) can also read shareable code objects list 740, e.g., by sending an appropriate message to control session 714 or message session 716 to request shareable code objects list 740. A connected accessory can also request a particular shareable code object from list 740, e.g., by sending an appropriate message to control session 714 or message session 716. Protocol manager 712 can coordinate delivery of the requested shareable code object, e.g., via control session 714, message session 716, or data transfer session 718.

It will be appreciated that the protocol stack described herein is illustrative and that variations and modifications are possible. User device 602 can support any type of application, and applications can be launched or exited under control of a user or another process. It is contemplated that lower level processes (including support layer 730, protocol manager 708, and protocol daemon 704) can be implemented in software and/or firmware and configured to be automatically started at device power-up and to terminate only on power down or when various abnormal conditions are detected. In some embodiments, protocol manager 708 and protocol daemon 704 are always operating, but session layer 712, link layer 710, and port 706 are initiated only when a compatible accessory is detected and are terminated when no accessories are connected. The processes may go into inactive states to minimize resource consumption when not in use. Further, not all of the levels and processes shown herein are required; for instance, in some embodiments, applications might communicate directly with the protocol manager or protocol daemon. In other embodiments, processes shown as separate in FIG. 7 can be combined, or a single block in FIG. 7 can correspond to multiple processes executing on the device.

It is also to be understood that accessory 604 can implement a similar protocol stack. Communication requires that both user device 602 and accessory 604 have suitably configured hardware and/or software components to send and receive messages that are mutually comprehensible (e.g., conforming to the accessory protocol at both the link layer and the session layer), but the implementation may be varied as desired.

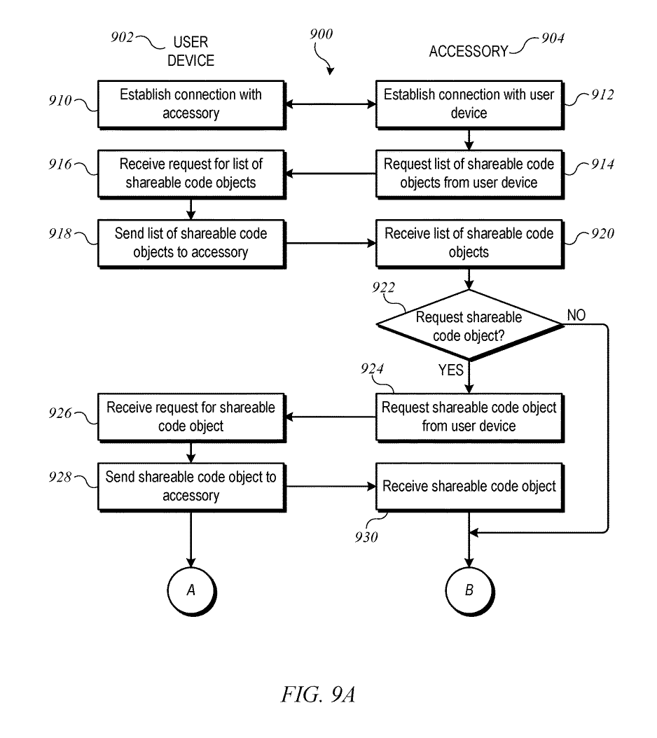

In some embodiments, the messages exchanged between a user device (e.g., user devices 102 of FIG. 1) and an accessory (e.g., accessories 110 of FIG. 1) can include messages relating to management of shareable code objects (e.g., shareable code object 120). FIG. 8 shows a table 800 listing examples of messages that can be exchanged according to an embodiment of the present invention. For each message, table 800 lists the message name (column 802), whether the message is sent from the user device (D) to the accessory (A) or vice versa (column 804), and message parameters (column 806).

ProvideCodeObject message 810 can be sent by an accessory to provide a shareable code object to a user device, e.g., as described above with reference to FIG. 1. The message parameters can include an object type identifier and the object content (which can be the shareable code object). An object type identifier can be used to indicate the type of information contained in the shareable code object. For example, the object type identifier can indicate whether the object includes configuration settings (static data) or executable code. The object type identifier can also provide additional information about the content of the shareable code object. For instance, in the case of a shareable code object that includes configuration settings, the object type identifier can further specify a particular class of accessory (e.g., car seat, speaker dock, etc.) to which the configuration settings are applicable. In the case of a shareable code object that includes executable code, the object type identifier can indicate the type of code (e.g., script, compiled binary, run-time compilable code), requirements for executing the code (e.g., type of user device, operating system version), and an indication of how the code is to be used (e.g., for an app extension, the type identifier can specify which type of app extension is being provided, with the extension type being selected from a set of extension types recognized by operating systems of at least some user devices; examples are described below).

In some embodiments, ProvideCodeObject message 810 can be sent whenever an accessory (e.g., accessory 110(2) in FIG. 1) that has stored a shareable code object (e.g., shareable code object 120(1) in FIG. 1) connects with a user device (e.g., user device 102(1) in FIG. 1). In other embodiments, user device 102(1) and accessory 110(1) can exchange additional messages to determine whether shareable code object 120(1) should be sent. For example, a user might choose to disable shareable code objects on her devices, in which case user device 102(1) can instruct accessory 110(1) not to send ProvideCodeObject message 810. As another example, shareable code object 120(1) might include executable code that is not supported by a particular user device 102(1) (e.g., the executable code might be operative on tablet computers but not smart phones, or the executable code might require a particular version of a user-device operating system). In that case, accessory 110(1) can communicate with user device 102(1) to determine its device type and/or operating system version; if user device 102(1) does not support the executable code, then accessory 110(1) can determine not to send ProvideCodeObject message 810.

As described above with reference to FIGS. 2 and 3, a user device, e.g., device 102(1), can store shareable code objects, e.g., shareable code object 120(1), and provide stored shareable code objects to accessories, e.g., accessory 110(2). In some embodiments, user device 102(1) can provide shareable code object 120(1) to accessory 110(2) in response to a request from accessory 110(2). RequestCodeObject message 812 can be sent from accessory 110(2) to user device 102(1) to request a specific shareable code object, and ReturnCodeObject message 814 can be sent from user device 102(1) to provide the requested shareable code object to accessory 110(2). In some embodiments, each shareable code object stored on a particular user device can be uniquely identified by the object type identifier. This can be accomplished as a matter of design choice; for instance, if user device 102(1) receives a shareable code object having the same object type identifier as a previously stored shareable code object, the new shareable code object can overwrite the old. Other decision logic can also be used, e.g., determining respective modification date of the two shareable code objects and storing the more recently modified shareable code object (which can also be provided back to the accessory, thus providing a form of synchronization of shareable code objects across accessories). Other schemes for identifying specific shareable code objects to be provided to an accessory can also be used.

In some embodiments, prior to requesting a particular shareable code object, an accessory may obtain information as to what shareable code objects are available at a connected user device. Accordingly, RequestCodeObjectList message 816 can be sent from accessory 110 to connected user device 102 to request a list of shareable code objects stored at user device 102, and ReturnCodeObjectList message 818 can be sent from user device 102 to accessory 110 to provide the shareable code objects list (e.g., list 740). The shareable code objects list can include descriptive information for each stored shareable code object (e.g., an object type identifier, modification date indicating when the shareable code object was last modified, etc.). Based on information in the shareable code objects list, accessory 110 can select and request desired shareable code objects from user device 102.

It will be appreciated that the messages listed in table 800 are illustrative and that variations and modifications are possible. Other messages can be supported in addition to or instead of those shown. For example, in some embodiments, an accessory can provide accessory type information to a user device, and the user device can inform the accessory as to what (if any) shareable code objects are available that pertain to that accessory type. Further, in some embodiments, a shareable code object might be too large to send as a parameter of an accessory-protocol message, and a transfer session as described above or other techniques can be used to transfer larger shareable code objects.

Using messages such as those listed in table 800, a user device (e.g., any of user devices 102 of FIG. 1) can obtain shareable code objects (e.g., shareable code object 120(1)) from an accessory (e.g., any of accessories 110 of FIG. 1) and/or provide shareable code objects to an accessory. Examples of specific processes for sharing shareable code objects between a user device (e.g., user device 102(1)) and an accessory (e.g., accessory 110(1) or 110(2)) will now be described.

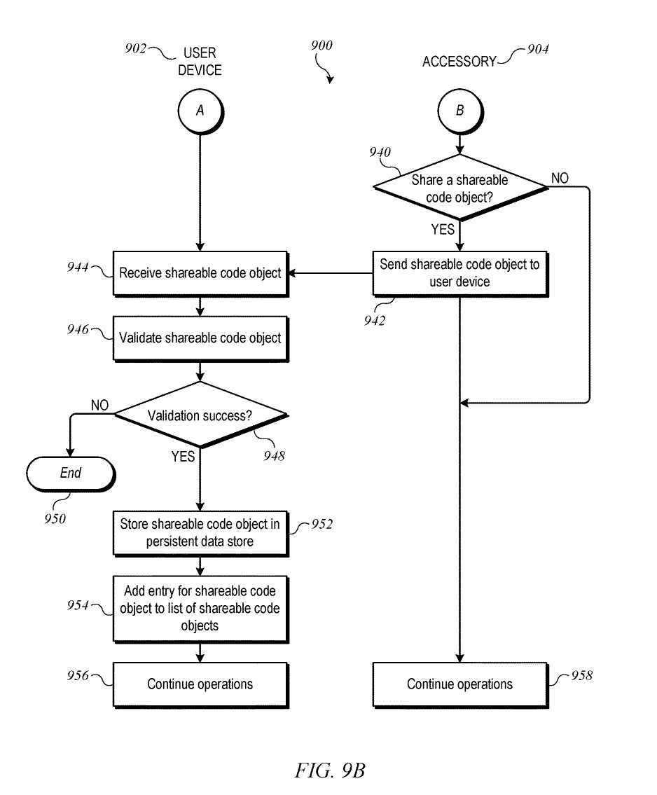

FIGS. 9A and 9B show a flow diagram of a process 900 for sharing a shareable code objects between a user device and an accessory according to an embodiment of the present invention. Portions of process 900 can be executed in a user device 902 (which can be, e.g., user device 102(1) of FIGS. 1-5), while other portions of process 900 can be executed in an accessory device 904 (which can be, e.g., accessory 110(1) or accessory 110(2) of FIGS. 1-5).

Referring first to FIG. 9A, process 900 can begin at blocks 910 and 912 when user device 902 and accessory 904 establish a connection with each other. Establishing a connection can be performed in accordance with an accessory communication protocol as described above. In some embodiments, establishing a connection can include either or both devices identifying themselves to each other (e.g., providing device-type information, information about capabilities and messages to be used during the connection, etc.). In some embodiments, establishing a connection can also include either or both devices authenticating themselves to each other. For example, accessory 904 can be required to provide a digital certificate to user device 902, and user device 902 can validate the certificate against a list of valid certificates (the list can be stored locally on user device 902 or remotely at support server 104 or another server as desired). User device 902 can also issue a cryptographic challenge to accessory 904, e.g., by sending a random nonce or the like, and accessory 904 can be required to sign the challenge with a private key. User device 902 can verify the signature using a public key associated with the accessory's digital certificate. Other authentication techniques can also be used, and authentication can be bidirectional if desired.

Once the connection is established, at block 914, accessory 904 can request a list of shareable code objects from user device 902, e.g., using RequestCodeObjectList message 812. At block 916, user device 902 can receive the request, and at block 918, user device 902 can provide the list of shareable code objects, e.g., using ReturnCodeObjectList message 814. As described above, in some embodiments, the list can include all shareable code objects that are currently stored in persistent storage of user device 902. In other embodiments, the list can include a subset of stored shareable code objects. For example, user device 902 can filter the list based on accessory-type information provided by accessory 904. As another example, the request from accessory 904 can specify a particular object type identifier or other selection criteria, and user device 902 can filter the list of stored shareable code objects based on the specified criteria. At block 920, accessory 904 can receive the list of shareable code objects from user device 902.

At block 922, accessory 904 can determine whether to request a shareable code object from user device 902. For example, accessory 904 can determine whether any of the shareable code objects in the received list has an object type identifier that indicates the presence of information usable by the accessory. As another example, accessory 904 can compare the modification date of a shareable code object on the list with a modification date for its own locally stored settings and can determine whether to request a shareable code object based on whether the version on the user device is newer (or older) than the locally-stored version. The particular decision logic may depend on the accessory. For instance, in the case where accessory 904 implements a car seat, accessory 904 might not know whether currently connected user device 902 is associated with the same user as the user who established the current settings of the car seat; accordingly, accessory 904 might always obtain and use a shareable code object containing seat settings from any user device 902 that connects and has a shareable code object of the appropriate object type. In other embodiments, different decision logic can be implemented.

At block 924, in response to a decision to request a shareable code object, accessory 904 can send a request for the shareable code object to user device 902, e.g., using RequestCodeObject message 812. At block 926, user device 902 can receive the request, and at block 928, user device 902 can send the requested shareable code object to accessory 904, e.g., using ReturnCodeObject message 814. In some embodiments, user device 902 can prompt the user to confirm that information should be provided to the accessory prior to sending the shareable code object at block 928. At block 930, accessory 904 can receive the shareable code object. Thereafter, accessory 904 can use the shareable code object. For instance, accessory 904 can read settings data from the shareable code object and adjust its settings accordingly. Process 900 can proceed at nodes A and B.

As shown in FIG. 9B, at block 940, accessory 904 can determine whether to share a shareable code object with user device 902. The determination can occur at any point during interoperation of accessory 904 and user device 902 and need not have any particular temporal relationship to the obtaining of a shareable code object by accessory 904. In addition, accessory 904 can determine to share a shareable code object with user device 902 regardless of whether accessory 904 has previously obtained a shareable code object from user device 902.

The determination at block 940 can be made according to various decision rules. For example, if a shareable code object stored at accessory 904 contains configuration settings and the user changes the configuration settings, accessory 904 may determine to share an updated shareable code object, reflecting the changed settings, with user device 102, so that user device 102 will have the user's latest preferences. As another example, accessory 904 can send a message to user device 902 offering to share a shareable code object; this message can include information about the shareable code object, such as an object type identifier, modification date, or the like. User device 902 can determine whether to accept the offer and can send an appropriate response message to accessory 904. In some embodiments, either accessory 904 or user device 902 can present a prompt to the user asking the user whether to allow information sharing, and the determination at block 940 can depend on the user's response. Other decision logic can also be implemented.

Whenever accessory 904 determines at block 940 that a shareable code object should be shared, accessory 904 can send the shareable code object to user device 902 at block 942.

At block 944, user device 902 can receive the shareable data object from accessory 904. In some embodiments, it may be desirable for user device 902 to perform validation operations on a shareable code object received from an accessory (e.g., to prevent ill-formatted or otherwise problematic code objects from being shared with other devices). Accordingly, at block 946, user device 902 can perform one or more validation operations on the shareable code object; specific examples are described below. The validation operations at block 946 can result in a determination at block 948 as to whether the validation operations succeeded or failed. In the event of failure, process 900 can end at block 950. In some embodiments, ending at block 950 can include terminating the connection with accessory 904. In other embodiments, the connection can continue and user device 902 can simply discard the received shareable code object, with or without a notification to accessory 904.

If, at block 948, the validation operations result in success, then at block 952, user device 902 can store the received shareable data object in a persistent data store (e.g., nonvolatile memory). At block 954, user device 902 can add an entry for the received shareable data object to its list of stored shareable code objects. This list can be the same list used to respond to accessory requests at block 918.

At blocks 956 and 958, interoperation of user device 902 and accessory 904 can continue. In some embodiments, such interoperation can result in accessory 904 providing more shareable code objects (including updated versions of a previously shared code object) to user device 902 and/or requesting additional shareable code objects from user device 902. Interoperation can continue until the connection between user device 902 and accessory 904 is terminated, which can occur, e.g., when a cable is disconnected, when the devices move out of wireless communication range, when the user manually operates a disconnect control on either device, when either device has its communication circuitry powered down (e.g., entering an “airplane” mode in which wireless radio transceivers are powered off), or when a change in operating conditions results in one or the other of the devices determining that the connection should be terminated.

Through multiple instances of process 900 during connections with different accessories, a user device can obtain a shareable code object from one accessory and subsequently provide the shareable code object to a different accessory (or back to the same accessory, e.g., after disconnecting and reconnecting). Thus, for instance, as shown in FIGS. 1 and 2, user device 102(1) can obtain shareable code object 120(1) from accessory 110(1) during a first instance of executing process 900 and can later provide shareable code object 120(1) to accessory 110(2) (or back to accessory 110(1)) during a second instance of executing process 900.

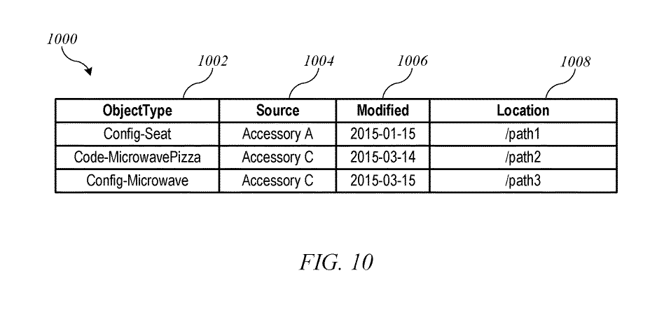

Such sharing can be facilitated by having the user device maintain a list of the shareable code objects it has received and stored. FIG. 10 shows an example of a list 1000 of shareable code objects according to an embodiment of the present invention. List 1000 can be stored, e.g., as list 740 of FIG. 7. In this example, list 1000 can be a lookup table indexed by object type (column 1002). Other data structures can be substituted. For each shareable code object, a row is provided in list 1000 to store and organize information about the shareable code object. In this example, the information includes object type (column 1002), an identifier of the accessory “source” from which the shareable code object was received (column 1004), a modification date (column 1006), and a location (column 1008).

Object type (column 1002) can include information identifying the type of the shareable code object. For instance, an object type identifier as described above with reference to ProvideCodeObject message 810 can be included. In some embodiments, a set of supported object types can be defined within system 100, and any shareable code object that does not have a supported object type can be discarded.

Source identifier (column 1004) can provide information about the accessory from which the shareable code object was received. In some embodiments, this information can include an identifier of the specific accessory (e.g., manufacturer, model, and serial number). Different information elements can be used to identify the accessory with more or less specificity as desired (e.g., just the manufacturer, just an accessory type identifier, etc.).

Modification date (column 1006) can provide information about when the shareable code object was last modified. In some embodiments, rather than modifying an existing shareable code object, the user device can overwrite a stored shareable code object with a new one, and the date can indicate the date of receipt of the currently stored shareable code object. In some embodiments, the accessory can provide a modification date when it provides a shareable code object. This can allow decision logic within the user device and/or the accessory to determine which shareable code object to store or use in the event the devices have instances of the same shareable code object with different dates.

Location (column 1008) can provide a pointer, URI, or other reference to the location where the shareable code object is stored in the persistent data store of the user device.

When an accessory requests information about stored shareable code objects (e.g., using RequestCodeObjectList message 816), the user device can access list 1000 to provide the information. It should be understood that not all information in list 1000 need be provided in response to an accessory request. For example, the user device can provide just the object types, or just the object types and modification dates.

When an accessory requests a particular shareable code object (e.g., using RequestCodeObject message 810), the user device can access list 1000 to look up the location of the object, then retrieve the object from the specified location. Thus, for example, an accessory can request a shareable code object based on object type.

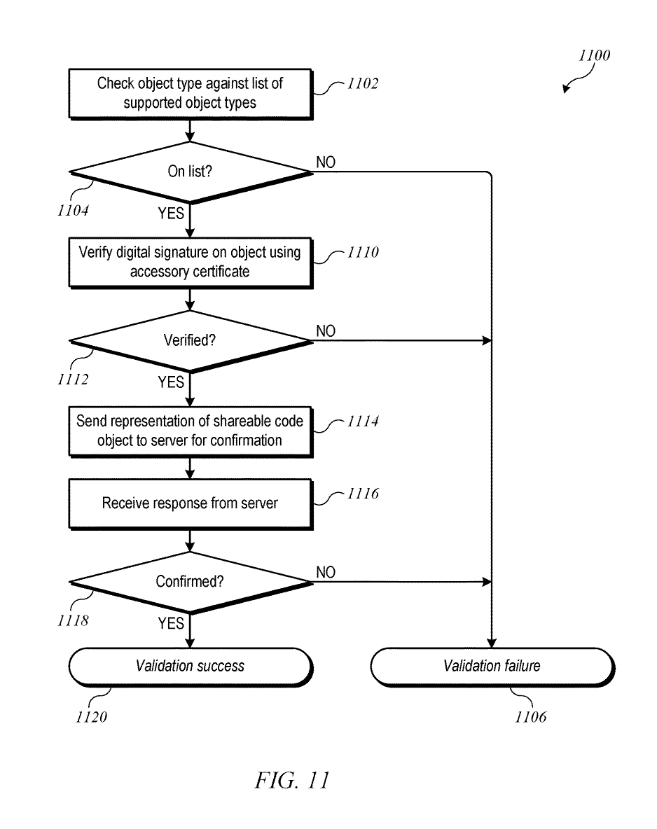

As noted above, it may be desirable to validate a shareable code object received from an accessory prior to adding the shareable code object to list 1000, e.g., by performing one or more validation operations at block 946 of process 900. FIG. 11 is a flow diagram of a process 1100 that can be used to validate a shareable code object according to an embodiment of the present invention. Process 1100 can be implemented in a user device (e.g., user device 902 of FIGS. 9A-9B, or any of user devices 102 of FIG. 1) and can be implemented, e.g., at block 946 of process 900. Process 1100 incorporates multiple validation tests, and validation succeeds if the shareable code object passes all of the tests.

For example, at block 1102, user device 902 can check an object type (e.g., object type identifier) specified for the shareable code object against a list of object types supported within system 100. For example, system code provisioned on user device 902 can include the list of supported object types, and accessory 904 can specify the object type of each shareable code object it provides to user device 902. (If the accessory fails to specify an object type, the user device can reject the shareable code object.) If, at decision block 1104, the object type specified for the shareable code object is not in the list of supported object types, then validation fails and process 1100 can end at block 1106. If the object type specified for the shareable code object is in the list of supported code objects, validation process 1100 can continue. In some embodiments, user device 902 can perform additional tests to verify that the shareable code object is consistent with the object type specified by the accessory (e.g., a shareable code object of a particular object type may have an expected size or size range, a particular header or other structural elements, etc.).

Another validation test can be based on an accessory digital certificate. As described above, establishing a connection between a user device and an accessory can include the accessory providing a digital certificate that the user device can use to authenticate the accessory. In some embodiments, the accessory can be required to digitally sign any shareable code object it sends to the user device, using the private key associated with the digital certificate. Accordingly, at block 1110, the user device can verify a digital signature applied to the shareable code object by the accessory. If, at decision block 1112, the digital signature is not verified, then validation fails and process 1100 can end at block 1106.

Another validation test can use a server (e.g., support server 104) to further confirm the content and/or safety of the shareable code object. At block 1114, user device 902 can send a representation of the shareable code object to a server (e.g., support server 104) for validation. Support server 104 can perform various operations. For example, support server 104 rather than user device 902 may perform checking of shareable object features such as expected size or size range, headers and/or other structural elements, and so on. If the shareable code object includes executable code, support server 104 may be able to execute the code in a “sandbox” environment (where the code is prevented from affecting any other processes) to confirm that the code is operative and safe for the user device. In addition or instead, support server 104 may be able to compare the code to a set of known-safe code objects that support server 104 maintains; if the code matches, then it can be confirmed. In some embodiments, support server 104 may also perform malware-detection processes (including known processes for recognizing various forms of malicious code or data) and can confirm or reject the shareable code object according to the results of such processes. Other confirmation operations can be included in addition to or instead of these examples. At block 1116, user device 902 can receive a confirmation response from support server 104. If, at decision block 1118, the shareable code object is not confirmed by the server, then validation fails and process 1100 can end at block 1106. If all validation operations (including decision blocks 1104, 1112, and 1118) report success, then validation succeeds and process 1100 can end at block 1120.

As described above, user device 902 can determine to keep or reject a received shareable code object based on whether validation process 1100 ends with success or failure. In some embodiments, user device 902 can report the result of validation process 1100 to accessory 904 that was the source of the shareable data object.

Processes 900 and 1100 support sharing of shareable code objects from one accessory to another. In some embodiments, shareable code objects can also be shared among multiple user devices belonging to the same user. This can be done, for example, during a synchronization operation in which the various user devices (e.g., user devices 102(1) and 102(2) of FIG. 1) synchronize with a server (e.g., support server 104 of FIG. 1).

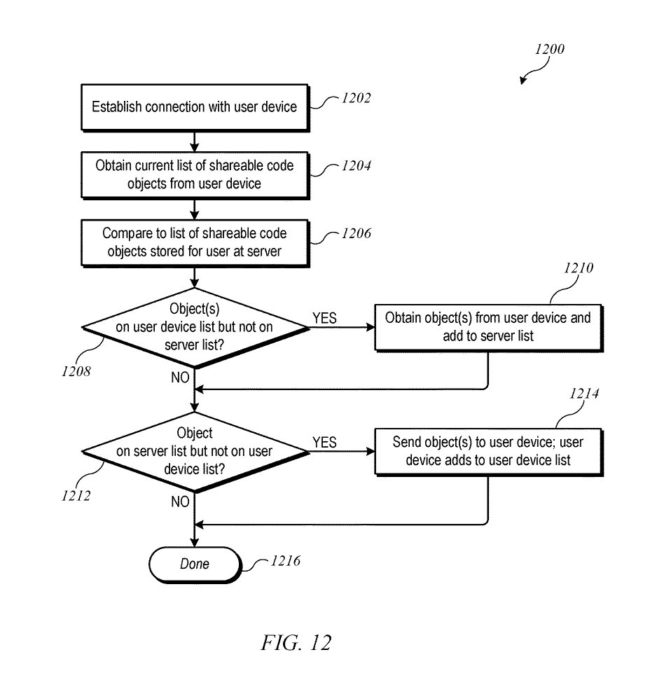

FIG. 12 is a flow diagram of a process 1200 for synchronizing shareable code objects between a user device (e.g., any of user devices 102(1) or 102(2) of FIG. 1) and a server (e.g., support server 104 of FIG. 1) according to an embodiment of the present invention. Process 1200 can be implemented at the server.

At block 1202, support server 104 can establish connection with a user device, e.g., user device 102(1) or 102(2). At block 1204, support server 104 can obtain from the connected user device 102 a list of shareable code objects currently stored on that user device. At block 1206, support server 104 can compare this list to its own list of shareable code objects stored for the user's devices (which can reflect the results of prior synchronization operations with any of user devices 120). At block 1208, support server 104 can determine whether any shareable code objects are on the user device's list that are not also on the server's list. If so, then at block 1210, support server 104 can obtain the shareable code object from user device 102 and add the shareable code object to its own list. Block 1210 can be repeated if there are multiple shareable code objects are on the user device's list that are not also on the server's list.

At block 1212, support server 104 can determine whether any shareable code objects on the server's list are not also on the user device's list. If so, then at block 1214, support server 104 can send the shareable code object to user device 102, which can add the shareable code object to its list. Block 1214 can be repeated if there are multiple shareable code objects on the server's list that are not also on the user device's list. Process 1200 can end at block 1216. It is to be understood that process 1200 synchronizes shareable code objects, and other processes can be used to synchronize other types of data between a user device and the server.

By performing process 1200 with different user devices at different times, server 104 can facilitate sharing of shareable code objects across a user's devices. For example, a first synchronization operation between server 104 and user device 102(1) can result in shareable code object 120(1) being added to user account data 108, as shown in FIG. 2. A second synchronization operation between sever 104 and user device 102(2) can result in shareable code object 120(1) being added to user device 102(2), as shown in FIG. 5.

It will be appreciated that the processes described herein are illustrative and that variations and modifications are possible. Steps described as sequential may be executed in parallel, order of steps may be varied, and steps may be modified, combined, added or omitted. Sharing of shareable code objects between a user device and an accessory can occur at any time while the devices are connected, and such sharing can be conducted with or without an express user request. Similarly, synchronization of a user device with a server can occur at any time when the user device is able to establish a connection with the server, and synchronization can be initiated automatically or at express user request as desired. The sharing and synchronization techniques described herein can be agnostic as to the content of the shareable code object; thus any type of information can be shared across accessories and/or user devices.

In some embodiments, the user device may provide a settings menu via which the user can indicate various preferences related to shareable code objects. For instance, the user may select to not share code objects with a particular user device at all, to share code objects between the user device and accessories (all accessories or a user-selected subset accessories) but not to synchronize shareable code objects across user devices, or to share code objects between the user device and accessories (all accessories or a user-selected subset accessories) and also to synchronize shareable code objects across user devices. Further, in some embodiments, the user can also configure whether particular types of shareable code objects should or should not be shared (e.g., share static configuration data but not executable code). In operation, the user device can modify its behavior based on the user preferences.

In some embodiments, a shareable code object can include static information, such as configuration settings for an accessory. For instance, as described above, a shareable code object can include settings for a car seat to accommodate a specific user or for a microwave oven to heat a particular food.

In some embodiments, a shareable code object can include executable code that is to be executed by the user device. The object type identifier can be used to distinguish shareable code objects that include executable code from shareable code objects that contain only static information. For shareable code objects that include executable code, it may be desirable for the user device to expose the executable code to other processes for which the code is useful.

One specific example pertains to so-called “app extensions.” As used herein, an app extension can include a code segment associated with a “containing” app that can be invoked by a different app (or a system process) in connection with a specific function or operation. For instance, an app extension contained in a weather app can be invoked by a system notification process to provide weather data on a notification screen. Techniques for implementing app extensions are known in the art; one example can be found in the iOS 8 operating system produced and distributed by Apple Inc.

In some embodiments of the present invention, an app extension can be provided from an accessory rather than an app downloaded onto the user device (e.g., from an online app store). The app extension can be provided as a shareable code object to the user device, with an object type identifier identifying it as an app extension. If the implementation of app extensions in a particular operating environment defines a supported set of extension classes (as is the case for the iOS 8 operating system), the object type identifier can also specify the extension class.

The user device can expose an app extension received as a shareable code object from an accessory in a manner similar to app extensions provided within containing apps, thereby allowing various apps and/or system processes on the user device to invoke the shareable code object. In some embodiments, the app extension can implement functionality specific to the particular accessory. For instance, consider an accessory that includes a microphone. An app extension supplied by the microphone accessory to the user device can provide noise-reduction algorithms optimized for that microphone. An audio recording app on the user device can invoke the app extension to process signals received from the microphone accessory. In other examples, an app extension supplied by an accessory can provide specific tools or user-interface elements to be used when interacting with the accessory. In this manner, an accessory manufacturer can provide a user experience tailored to the accessory without having to provide a dedicated app.

App extensions can be provided from an accessory to a user device as a shareable code object using processes described herein. In some embodiments, app extensions might not be shared by the user device with other accessories (since the app extension code is executed on the user device rather than the accessory), but app extensions obtained from accessories as shareable code objects can be shared across user devices through synchronization in the manner described above.

While the invention has been described with respect to specific embodiments, one skilled in the art will recognize that numerous modifications are possible. Any number of user devices can obtain a shareable code object through synchronization operations as described above. In some embodiments, direct synchronization between user devices can be used in addition to or instead of server-based synchronization as described above. Further, a user device that stores a shareable code object can provide the shareable code object to any number of accessories with which it connects.

In some embodiments, a user can also share a shareable code object with other users. For example, suppose that a user, through experimentation, discovers a “recipe” of microwave oven settings for heating a particular food item (e.g., a slice of pizza) that produces an excellent result. As described above, assuming the microwave oven is operable as an accessory, the microwave oven settings can be represented as a shareable code object and provided by the microwave oven to a user device of the user. In some embodiments, the user can send the shareable code object to other users' devices, e.g., using short-range communication (such as NFC); using an ad-hoc network established using Bluetooth or Wi-Fi technologies (e.g., using the AirDrop® file sharing capability of various devices manufactured by Apple Inc.); as an email attachment, SMS message, or the like. The receiving user's device can be configured to recognize a shareable code object received from another user's device and add the shareable code object to its own list of such objects. In some embodiments, sharing of shareable code objects between users can be limited to particular object types (e.g., to prevent unauthorized sharing of copyrighted material).

In some embodiments, a shareable code object can include a “key” that is usable by the user device to obtain executable code or data from a server. For example, a user device can communicate with a support server or other server to download apps and/or media content, and in some cases, the user may need to pay for apps or content. A key obtained via a shareable code object may serve as authorization for the user device to download a particular app or other content without charge. As another example, the server can be configured to make a particular app available to a user device only if the user device presents a valid key. The user device can obtain the key from the accessory as a shareable code object and can present the key to the server in order to obtain an app that interoperates with the accessory.

Embodiments of the present invention can be realized using any combination of dedicated components and/or programmable processors and/or other programmable devices. The various processes described herein can be implemented on the same processor or different processors in any combination. Where components are described as being configured to perform certain operations, such configuration can be accomplished, e.g., by designing electronic circuits to perform the operation, by programming programmable electronic circuits (such as microprocessors) to perform the operation, or any combination thereof. Further, while the embodiments described above may make reference to specific hardware and software components, those skilled in the art will appreciate that different combinations of hardware and/or software components may also be used and that particular operations described as being implemented in hardware might also be implemented in software or vice versa.

Computer programs incorporating various features of the present invention may be encoded and stored on various computer readable storage media; suitable media include magnetic disk or tape, optical storage media such as compact disk (CD) or DVD (digital versatile disk), flash memory, and other non-transitory media. (It is understood that “storage” of data is distinct from propagation of data using transitory media such as carrier waves.) Computer readable media encoded with the program code may be packaged with a compatible electronic device, or the program code may be provided separately from electronic devices (e.g., via Internet download or as a separately packaged computer-readable storage medium).

Thus, although the invention has been described with respect to specific embodiments, it will be appreciated that the invention is intended to cover all modifications and equivalents within the scope of the following claims.

What is claimed is:

1. A method comprising:
establishing, by a user device, a connection with a first accessory using an accessory protocol;
receiving, via the connection, by a first process executing on the user device, a shareable code object from the first accessory;
storing, by the first process executing on the user device, the shareable code object in a persistent data store of the user device;
adding, by the first process executing on the user device, an entry representing the shareable code object to a list of shareable code objects, the list of shareable code objects being persistently accessible to processes executing on the user device; thereafter
reading, by a second process executing on the user device, the entry from the list of shareable code objects; and
obtaining, by the second process executing on the user device, the shareable code object from the persistent data store.

2. The method of claim 1 wherein the shareable code object includes configuration data for a component of the first accessory.

3. The method of claim 2 wherein the second process is a process that communicates with a second accessory and wherein the second process obtains the shareable code object from the persistent data store in response to a request from the second accessory, the method further comprising:
providing, by the second process, the shareable code object to the second accessory.

4. The method of claim 3 wherein the first accessory and the second accessory are the same accessory.

5. The method of claim 1 wherein the shareable code object includes executable program code.

6. The method of claim 5 wherein the executable program code includes app extension code that is invocable by an app on the user device.

7. The method of claim 1 further comprising:
synchronizing, by the user device, the shareable code object with a user account at a server system, wherein the server system synchronizes shareable code objects among two or more devices associated with the user account.

8. The method of claim 1 further comprising:
prior to storing the shareable code object in the persistent data store, performing, by the user device, a validation operation on the shareable code object,
wherein the shareable data object is rejected in the event that the validation operation fails.

9. The method of claim 8 wherein the validation operation includes:
sending a representation of the shareable code object to a server; and
receiving a response from the server.

10. An electronic device comprising:
a user interface;
an accessory interface to communicate with an accessory; and
a processing subsystem coupled to the user interface and the accessory interface, the processing subsystem configured to:
establish a connection with a first accessory via the accessory interface using an accessory protocol;
execute a first process that receives, via the connection, a shareable code object from the first accessory, stores the shareable code object in a persistent data store of the user device, and adds an entry representing the shareable code object to a list of shareable code objects, the list of shareable code objects being persistently accessible to processes executing on the electronic device; and
execute a second process that reads the entry from the list of shareable code objects and obtains the shareable code object from the persistent data store.

11. The electronic device of claim 10 wherein the shareable code object includes configuration data for a component of the first accessory.

12. The electronic device of claim 11 wherein the second process is a process that communicates with a second accessory, wherein the second process obtains the shareable code object from the persistent data store in response to a request from the second accessory, and wherein the second process provides the shareable code object to the second accessory.

13. The electronic device of claim 12 wherein the first accessory and the second accessory are the same accessory.

14. The electronic device of claim 10 wherein the shareable code object includes executable program code.

15. The electronic device of claim 10 further comprising:
a network interface,
wherein the processing subsystem is further configured to synchronize the shareable code object with a user account at a server system, wherein the server system synchronizes shareable code objects among two or more devices associated with the user account.

16. A computer-readable storage medium having stored thereon program code instructions that, when executed by a processor in an electronic device, cause the processor to perform a method comprising:
establishing a connection with a first accessory using an accessory protocol;
executing a first process that includes:
receiving, via the connection, a shareable code object from the first accessory;
storing the shareable code object in a persistent data store of the user device; and
adding an entry representing the shareable code object to a list of shareable code objects, the list of shareable code objects being persistently accessible to processes executing on the user device; and
executing a second process that includes:
reading the entry from the list of shareable code objects; and
obtaining the shareable code object from the persistent data store.

17. The computer-readable storage medium of claim 16 wherein the shareable code object includes configuration data for a component of the first accessory.

18. The computer-readable storage medium of claim 17 wherein the second process is a process that communicates with a second accessory, wherein the second process obtains the shareable code object from the persistent data store in response to a request from the second accessory, and wherein the method further comprises:
providing, by the second process, the shareable code object to the second accessory.

19. The computer-readable storage medium of claim 16 wherein the shareable code object includes executable program code.

20. The computer-readable storage medium of claim 16 wherein the method further comprises:
synchronizing, by the user device, the shareable code object with a user account at a server system, wherein the server system synchronizes shareable code objects among two or more devices associated with the user account.

21. The computer-readable storage medium of claim 16 wherein the method further comprises:
prior to storing the shareable code object in the persistent data store, performing, by the user device, a validation operation on the shareable code object,
wherein the shareable data object is rejected in the event that the validation operation fails.

22. The computer-readable storage medium of claim 16 wherein the second process is executed after the first process terminates.
